(19) United States
(12) Patent Application Publication
(10) Pub. No.: US 2019/0270857 A1
(43) Pub. Date: Sep. 5, 2019

(54) PLANARIZATION COATING FOR FLEXIBLE PRINTED ELECTRONICS

(71) Applicant: XEROX CORPORATION, Norwalk, CT (US)

(72) Inventors: Jin Wu, Rochester, NY (US); Lin Ma, Pittsford, NY (US)

(73) Assignee: XEROX CORPORATION, NORWALK, CT (US)

(21) Appl. No.: 15/911,664

(22) Filed: Mar. 5, 2018

(51) Int. Cl. C08J 7/04; C09D 4/06; C08J 3/24

(52) U.S. Cl. CPC C08J 7/047; C09D 4/06; C08J 2475/06; C08J 2367/00; C08J 3/245

(57) ABSTRACT

Provided is a planarization coating composition for polyester substrates comprising at least one acrylic polyol, at least one melamine carbamate crosslinker, and optionally at least one acid catalyst, wherein the at least one melamine carbamate is free of formaldehyde. Also provided herein is a method of making a coated polyester substrate, as well as planarization-coated polyester substrates.

### DETAILED DESCRIPTION

### Field of the Disclosure

This disclosure relates generally to a planarization coating for use in the roll-to-roll fabrication of materials, such as flexible printed electronics. In particular, this disclosure relates to a planarization coating composition comprising at least one acrylic polyol, at least one melamine resin that is substantially free of formaldehyde, such as a melamine carbamate, at least one solvent, and optionally at least one acid catalyst. The planarization coating compositions disclosed herein may be applied over polyester substrates coated by roll-to-roll processes to fabricate printed electronics. The planarization coating compositions disclosed herein have excellent adhesion properties to the polyester substrate below and to the electrode above, enhanced chemical and thermal stability, and no negative impact on electrode conductivity. In addition, formaldehyde is not used in the planarization coating composition, nor is it generated during thermal curing of the planarization coating.

### Background

Memory devices typically comprise memory cells having a pair of electrodes with memory material, such as a ferroelectric memory material, between them. The memory cells are provided on rigid substrates such as silicon or glass. However, flexible substrates may be desirable for certain new technologies, such as flexible printed electronics, which may be manufactured by roll-to-roll processing methods. Flexible printed electronics have attracted great interest from both academia and industry, and they have potential applications in many areas, including cyber skins for robotic devices, transistors, batteries, wearable electronics, sensors, and displays. Flexible printed electronics may be produced using flexible substrates, such as, for example, polyimides, polyethylene naphthalate (PEN), and polyethylene terephthalate (PET).

Good surface quality of the substrates is desirable to reduce defects and/or to enhance yield during roll-to-roll fabrication of flexible printed electronics. PEN and PET substrates have ideal transparency and affordability, but are limited by their low process temperature ceilings and high coefficients of thermal expansion. Processing PEN or PET substrates at even moderate temperatures may result in increased surface roughness due to the migration of oligomers to the surface of the substrate. This roughness is known to degrade optical and electrical device performance, as it impairs the deposition of a conductive composition, such as an electrode, on the surface of the substrate.

Therefore, planarization coatings applied to the surface of the substrates may act to smooth the surface of the device, serving, for example, as a barrier to the cyclic oligomer migration, thereby enhancing overall device performance and yield. Known planarization coatings, however, may be insufficient and/or result in low device yield. Accordingly, there is a need in the art for the development of improved planarization coatings, including planarization coatings having chemical and mechanical stability, good conductivity, and good adhesion to both the conductive compositions and the substrates.

### SUMMARY

Disclosed herein is a planarization coating composition comprising at least one acrylic polyol; at least one melamine carbamate crosslinker; at least one solvent; and optionally at least one acid catalyst, wherein the at least one melamine carbamate carbamate is free of formaldehyde. In certain embodiments, the at least one melamine carbamate crosslinker is a tris(alkoxycarbonylamino) triazine, such as a compound of the formula:

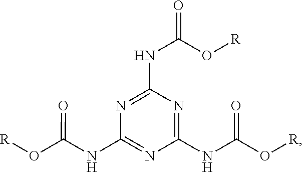

wherein R is chosen from methyl and n-butyl.

According to certain embodiments, the at least one melamine carbamate crosslinker is present in the composition in an amount ranging from about 5 wt % to about 65 wt %, based on the total weight of solids in the composition, and in certain embodiments, the at least one acrylic polyol is present in the composition in an amount ranging from about 35 wt % to about 95 wt %, based on the total weight of solids in the composition. According to certain embodiments of the disclosure, the at least one solvent is methylene chloride, and according to other various embodiments, the at least one acid catalyst is chosen from dodecylbenzene sulfonic acid, trifluoromethane sulfonic acid, polyphosphoric acid, dimethyl acid pyrophosphate, dinonyl naphthalene disulfonic acid, para-toluenesulfonic acid, oxalic acid, maleic acid, carboxylic acid, ascorbic acid, malonic acid, succinic acid, tartaric acid, citric acid, and methanesulfonic acid. In certain embodiments, the at least one acid catalyst is present in the composition in an amount ranging from about 0.5 wt % to about 6 wt %, based on the total weight of solids in the composition.

Also disclosed herein is a method of making a planarization-coated substrate for use with flexible printed electronics comprising providing a polyester substrate; depositing over the polyester substrate a planarization coating composition comprising at least one acrylic polyol, at least one melamine carbamate crosslinker, at least one solvent, and optionally at least one acid catalyst, wherein the at least one melamine carbamate crosslinker is free of formaldehyde; and curing the planarization coating composition to form a cured planarization film adhered to the polyester substrate.

In certain embodiments of the disclosed methods of making a planarization-coated substrate, the planarization coating composition is cured at a temperature ranging from about 100° C. to about 140° C., and, according to certain embodiments, the planarization coating composition is cured for a time ranging from about 5 minutes to about 20 minutes. According to certain embodiments of the methods disclosed herein, the polyester substrate is chosen from polyethylene naphthalate and polyethylene terephthalate.

Also diclosed herein are planarization-coated substrates for use in flexible printing electronics comprising a polyester substrate; and a cured planarization film adhered over the polyester substrate comprising at least one acrylic polyol, at least one melamine carbamate crosslinker, at least one solvent, and optionally at least one acid catalyst, wherein the at least one melamine carbamate crosslinker is free of formaldehyde.

According to certain embodiments, the cured planarization film has a thickness ranging from about 0.1 micron to about 20 microns, and in certain embodiments, the planarization-coated substrate has a surface roughness Rₐ value ranging from about 0.1 nm to about 15 nm. In various embodiments of the disclosure, the planarization-coated substrate further comprises at least one conductive composition deposited over the cured planarization film, and according to certain embodiments, the conductive composition has a conductivity ranging from about 2 ohms to about 100 ohms.

It is to be understood that both the foregoing general description and the following detailed description are exemplary and explanatory only and are not restrictive of the present teachings, as claimed.

### DESCRIPTION OF THE EMBODIMENTS

Reference will now be made in detail to embodiments of the present teachings. In the following description, reference is made to exemplary embodiments in which the present teachings may be practiced. The following description is, therefore, merely exemplary.

The planarization coating compositions disclosed herein have the ability to enable electronic circuits on conventional substrates such as polycarbonates, polyethylene terephthalate (PET), polyimides, and polyethylene naphthalate (PEN), while also exhibiting suitable adhesion, suitable planarization characteristics, and combatility with electronic inks and devices.

In certain embodiments there is a planarization coating composition comprising at least one acrylic polyol, at least one melamine resin crosslinker that is free of formaldehyde (for example, a melamine carbamate crosslinker), and optionally at least acid catalyst. In certain embodiments the planarization coating composition further comprises at least one solvent. The terms “substantially free of” and “free of” as used herein indicate that the composition comprises no effective amount of the material, such as 0% or an amount that is chemically insignicant, having no effect on the composition or its properties.

In certain embodiments, the planarization coating compositions disclosed herein comprise at least one acrylic polyol. Exemplary acrylic polyols include copolymers of derivatives of acrylic and methacrylic acid, including acrylic and methacrylic esters, and compounds containing nitrile and amide groups, and other optional monomers. The acrylic esters can be selected from, for example, n-alkyl acrylates wherein alkyl contains, in certain embodiments, from 1 to about 25 carbon atoms, such as methyl, ethyl, propyl, butyl, pentyl, hexyl, heptyl, octyl, nonyl, decyl, dodecyl, tetradecyl, or hexadecyl acrylate; secondary and branched-chain alkyl acrylates such as isopropyl, isobutyl, sec-butyl, 2-ethylhexyl, or 2-ethylbutyl acrylate; olefinic acrylates such as allyl, 2-methylallyl, furfuryl, or 2-butenyl acrylate; aminoalkyl acrylates such as 2-(dimethylamino)ethyl, 2-(diethylamino)ethyl, 2-(dibutylamino)ethyl, or 3-(diethylamino)propyl acrylate; ether acrylates such as 2-methoxyethyl, 2-ethoxyethyl, tetrahydrofurfuryl, or 2-butoxyethyl acrylate; cycloalkyl acrylates such as cyclohexyl, 4-methylcyclohexyl, or 3,3,5-trimethylcyclohexyl acrylate; halogenated alkyl acrylates such as 2-bromoethyl, 2-chloroethyl, or 2,3-dibromopropyl acrylate; glycol acrylates and diacrylates such as ethylene glycol, propylene glycol, 1,3-propanediol, 1,4-butanediol, diethylene glycol, 1,5-pentanediol, triethylene glycol, dipropylene glycol, 2,5-hexanediol, 2,2-diethyl-1,3-propanediol, 2-ethyl-1,3-hexanediol, or 1,10-decanediol acrylate, and diacrylate. Examples of methacrylic esters include, for example, alkyl methacrylates such as methyl, ethyl, propyl, isopropyl, n-butyl, isobutyl, sec-butyl, t-butyl, n-hexyl, n-octyl, isooctyl, 2-ethylhexyl, n-decyl, or tetradecyl methacrylate; unsaturated alkyl methacrylates such as vinyl, allyl, oleyl, or 2-propynyl methacrylate; cycloalkyl methacrylates such as cyclohexyl, 1-methylcyclohexyl, 3-vinylcyclohexyl, 3,3,5-trimethylcyclohexyl, bornyl, isobornyl, or cyclopenta-2,4-dienyl methacrylate; aryl methacrylates such as phenyl, benzyl, or nonylphenyl methacrylate; hydroxyalkyl methacrylates such as 2-hydroxyethyl, 2-hydroxypropyl, 3-hydroxypropyl, or 3,4-dihydroxybutyl methacrylate; ether methacrylates such as methoxymethyl, ethoxymethyl, 2-ethoxy ethoxymethyl, allyloxymethyl, benzyloxymethyl, cyclohexyloxymethyl, 1-ethoxyethyl, 2-ethoxyethyl, 2-butoxyethyl, 1-methyl-(2-vinyloxy)ethyl, methoxymethoxyethyl, methoxyethoxyethyl, vinyloxyethoxyethyl, 1-butoxypropyl, 1-ethoxybutyl, tetrahydrofurfuryl, or furfuryl methacrylate; oxiranyl methacrylates such as glycidyl, 2,3-epoxybutyl, 3,4-epoxybutyl, 2,3-epoxycyclohexyl, or 10,11-epoxyundecyl methacrylate; aminoalkyl methacrylates such as 2-dimethylaminoethyl, 2-diethylaminoethyl, 2-t-octylaminoethyl, N,N-dibutylaminoethyl, 3-diethylaminopropyl, 7-amino-3,4-dimethyloctyl, N-methylformamidoethyl, or 2-ureidoethyl methacrylate; glycol dimethacrylates such as methylene, ethylene glycol, 1,2-propanediol, 1,3-butanediol, 1,4-butanediol, 2,5-dimethyl-1,6-hexanediol, 1,10-decanediol, diethylene glycol, or triethylene glycol dimethacrylate; trimethacrylates such as trimethylolpropane trimethacrylate; carbonyl-containing methacrylates such as carboxymethyl, 2-carboxyethyl, acetonyl, oxazolidinylethyl, N-(2-methacryloyloxyethyl)-2-pyrrolidinone, N-methacryloyl-2-pyrrolidinone, N-(metharyloyloxy)formamide, N-methacryloylmorpholine, or tris(2-methacryloxyethyl)amine methacrylate; other nitrogen-containing methacrylates such as 2-methacryloyloxyethylmethyl cyanamide, methacryloyloxyethyl trimethylammonium chloride, N-(methacryloyloxy-ethyl)diisobutylketimine, cyanomethyl, or 2-cyanoethyl methacrylate; halogenated alkyl methacrylates such as chloromethyl, 1,3-dichloro-2-propyl, 4-bromophenyl, 2-bromoethyl, 2,3-dibromopropyl, or 2-iodoethyl methacrylate; sulfur-containing methacrylates such as methylthiol, butylthiol, ethylsulfonylethyl, ethylsulfinylethyl, thiocyanatomethyl, 4-thiocyanatobutyl, methylsulfinylmethyl, 2-dodecylthioethyl methacrylate, or bis(methacryloyloxyethyl)sulfide; phosphorous-boron-silicon-containing methacrylates such as 2-(ethylenephosphino)propyl, dimethylphosphinomethyl, dimethylphosphonoethyl, diethylphosphatoethyl, 2-(dimethylphosphato)propyl, 2-(dibutylphosphono)ethyl methacrylate, diethyl methacryloylphosphonate, dipropyl methacryloyl phosphate, diethyl methacryloyl phosphite, 2-methacryloyloxyethyl diethyl phosphite, 2,3-butylene methacryloyl-oxyethyl borate, or methyldiethoxymethacryloyloxyethoxysilane. Exemplary methacrylic amides and nitriles include, for example, N-methylmethacrylamide, N-isopropylmethacrylamide, N-phenylmethacrylamide, N-(2-hydoxyethyl)methacrylamide, 1-methacryloylamido-2-methyl-2-propanol,4-methacryloylamido-4-methyl-2-pentanol, N-(methoxymethyl)methacrylamide, N-(dimethylaminoethyl)methacrylamide, N-(3-dimethylaminopropyl)methacrylamide, N-acetylmethacrylamide, N-methacryloylmaleamic acid, methacryloylamido acetonitrile, N-(2-cyanoethyl)methacrylamide, 1-methacryloylurea, N-phenyl-N-phenylethylmethacrylamide, N-(3-dibutylaminopropyl)methacrylamide, N,N-diethylmethacrylamide, N-(2-cyanoethyl)-N-methylmethacrylamide, N,N-bis(2-diethylaminoethyl)methacrylamide, N-methyl-N-phenylmethacrylamide, N,N′-methylenebismethacrylamide, N,N′-ethylenebismethacrylamide, and N-(diethylphosphono)methacrylamide. Further optional monomer examples include styrene, acrolein, acrylic anhydride, acrylonitrile, acryloyl chloride, methacrolein, methacrylonitrile, methacrylic anhydride, methacrylic acetic anhydride, methacryloyl chloride, methacryloyl bromide, itaconic acid, butadiene, vinyl chloride, vinylidene chloride, or vinyl acetate.

In certain embodiments, the at least one acrylic polyol may be present in an amount ranging from, for example, about 35% to about 95%, from about 50% to about 90%, from about 60% to about 80%, about 65%, or about 75%, by weight relative to the total weight of solids in the composition.

The planarization coating compositions disclosed herein further comprise at least one melamine resin that is free of formaldehyde. In certain embodiments, the melamine resin is a melamine carbamate. In certain embodiments, the melamine carbamate crosslinker is tris(alkoxycarbonylamino) triazine, such as Cymel® NF2000A available from Allnex Belgium SA/NV, the structure of which is shown below:

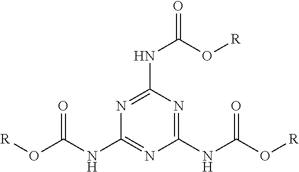

wherein R is an alkyl, such as a methyl group or an n-butyl group.

In certain embodiments, the melamine resin may be present in an amount ranging from, for example, about 5% to about 65%, from about 10% to about 50%, from about 20% to about 40%, about 25%, or about 35%, by weight relative to the total solids percent of the planarization coating composition.

The at least one acrylic polyol reacts with the melamine resin to produce a planarization coating composition. Crosslinking reactions between a tris(alkoxycarbonylamino) triazine and an acrylic polyol can be schematically illustrated as follows:

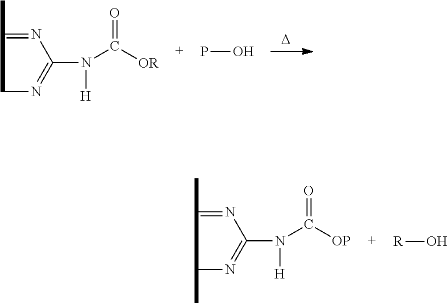

wherein P—OH represents the acrylic polyol.

The planarization coating compositions disclosed herein may further include at least one solvent. Any suitable or desired solvent can be selected. Certain exemplary solvents that may be mentioned include methylene chloride, propylene glycol methyl ether acetate, toluene, methyl isobutyl ketone, butylacetate, methoxypropylacetate, xylene, tripropyleneglycol monomethylether, dipropyleneglycol monomethylether, propoxylated neopentylglycoldiacrylate, and combinations thereof. In certain embodiments, the solvent can be a non-polar organic solvent, such as alkanes, alkenes, alcohols, and mixtures thereof. In certain embodiments, two or more solvents can be used. In certain embodiments, the solvent is methylene chloride.

The solvent can be provided in the planarization coating composition in any suitable amount. In certain embodiments, the solvent is present in an amount ranging from about 50% to about 90%, such as from about 60% to about 80%, or about 70%, by weight based on the total weight of the planarization coating composition.

The planarization coating compositions disclosed herein may, in certain embodiments, further comprise at least one acid catalyst. In certain embodiments disclosed herein, an acid catalyst can be included in the planarization composition to enhance the curing process. Acid catalysts that may be mentioned include, for example, dodecylbenzene sulfonic acid (DDBSA), trifluoromethane sulfonic acid, polyphosphoric acid, dimethyl acid pyrophosphate, dinonyl naphthalene disulfonic acid, para-toluenesulfonic acid, oxalic acid, maleic acid, carboxylic acid, ascorbic acid, malonic acid, succinic acid, tartaric acid, citric acid, methanesulfonic acid and combinations thereof. The catalyst can be present in the planarization coating composition in any suitable amount. In certain embodiments, the catalyst may be present in an amount ranging from about 0.1% to about 10%, such as from about 0.5% to about 6%, or from about 1% to about 4%, such as about 1%, by weight based on the total weight of solids in the planarization coating composition. In certain embodiments disclosed herein, the planarization coating composition is free of a catalyst.

In various embodiments, the planarization coating compositions disclosed herein are free, or substantially free, of formaldehyde. Formaldehyde is thought to be a toxin and carginogen. Accordingly, manufacturing processes that eliminate or reduce the use of formaldehyde may be desirable.

The planarization coating compositions disclosed herein may comprise from about 10 to about 50 weight percent solids, such as from about 15 to about 45 weight percent solids or from about 20 to about 30 weight percent solids, based on the total weight of the planarization coating composition. For example, in certain embodiments, the planarization coating composition contains a solids content ranging from about 10 to less than about 30 weight percent solids, based on the total weight of the composition.

The planarization coating compositions disclosed herein may be applied to any suitable substrate, including flexible substrates. Examples of such flexible substrates include polyesters such as polyethylene terephthalate, polyethylene naphthalate, polycarbonate; polyolefins such as polypropylene, polyvinyl chloride, and polystyrene; polyphenylene sulfides such as polyphenylene sulfide; polyamides; aromatic polyamides; polyether ketones; polyimides; acrylic resins; polymethylmethacrylate. In some embodiments, the substrate can be a rigid substrate such as glass, silicon, and quartz. Fabric and synthetic paper substrates may also be used. The material and the thickness of the substrate may be selected such that the substrate has a desired flexibility or rigidity.

The planarization coating composition may be deposited onto the substrate by any suitable technique. Exemplary techniques for the deposition of the planarization coating composition onto the substrate may include solution-based deposition techniques such as spin coating, dip coating, spray coating, slot die coating, flexographic printing, offset printing, screen printing, gravure printing, aerosol printing, ink jet printing, and the like, followed by annealing at suitable temperatures for curing.

The planarization coating composition can be cured at any suitable temperature for any suitable period of time. In certain embodiments, the coating composition disclosed herein can be cured at a temperature ranging from about 80° C. to about 160° C., such as from about 100° C. to about 140° C. or from about 120° C. to about 130° C., for a period of time ranging from about 1 minute to about 1 hour, such as about 5 minutes to about 20 minutes, or about 10 minutes to about 15 minutes. When cured, the planarization coating composition forms a planarization film on the surface of the substrate.

In certain embodiments disclosed herein, the planarization coating compositions may exhibit low shrinkage upon curing to the surface of the substrate. Low shrinkage may minimize or prevent curling, resulting in a coated substrate that is substantially flat. As used herein, “curl” indicates a distortion of the material such that the previously melted material does not retain its desired shape.

When cured, the planarized coating compositions disclosed herein may reduce the surface roughness of the coated substrate, i.e., the planarization film may have a low surface roughness compared to an uncoated substrate. Surface roughness may be measured through surface profilometry. Commercially available rough surface testers, such as the Wyko® Rough Surface Tester Light Interferometer, are non-contact optical profilers capable of very sensitive three-dimensional surface profilometry and surface roughness characterization. In certain embodiments, Rₐ and/or R_{z} values may be calculated for substrates coated with the planarization coating compositions disclosed herein. The Rₐ value of a surface is the average roughness of the surface, while the R_{z} value is the difference between the highest surface point (peak) and the lowest surface point (valley). In certain embodiments disclosed herein, a substrate coated with a planarization coating composition as described herein may have a surface roughness Rₐ value ranging from about 0.1 nm to about 15 nm, such as about 0.5 nm to about 5 nm, about 1 nm to about 3 nm, or about 1.5 nm to about 2.3 nm. In certain embodiments disclosed herein, a substrate coated with a planarization coating composition as described herein may have a surface roughness R_{z} value ranging from about 5 nm to about 50 nm, such as about 10 nm to about 30 nm, about 15 nm to about 25 nm, or about 17 nm to about 21 nm. These values are indicative of a uniform, smooth surface.

The cured planarization film may, in certain embodiments, be characterized by its average thickness. By “average thickness” it is meant the average value of the thickness of the cured planarization film across its surface. In certain embodiments, the average thickness of the cured planarization film is less than about 20 μm, such as less than about 10 μm, less than about 5 μm, less than about 1 μm, or less than about 800 nm. In certain embodiments the average thickness of the cured planarization film ranges from about 200 nm to about 15 μm, such as from about 1 μm to about 10 μm, from about 2 μm to about 5 μm, or about 5 μm. As demonstrated by the Examples below, despite their thinness, the cured planarization films that have been formed may adhere well to the underlying substrates and overlying conductive layers.

As described above, the cured planarization film may be used to facilitate the adhesion of other material layers, including conductive layers, to the underlying substrate. Thus, the cured planarization film may be part of a multilayer structure. In certain embodiments, the multilayer structure includes the substrate, the cured planarization film disposed over the surface of the substrate, and a conductive layer disposed over the surface of the cured planarization film. In certain embodiments, the multilayer structure includes the substrate, the cured planarization film directly on the surface of the substrate, and a conductive layer directly on the surface of the cured planarization film. The conductive layer may be formed from a conductive composition. The conductive composition may include a variety of materials, including metal nanoparticles. In certain embodiments, the metal nanoparticles include silver nanoparticles.

After deposition and curing of the planarization coating composition to form the cured planarization film as described above, the multilayer structure may be formed by depositing the conductive composition on or over the cured planarization film. Deposition may be accomplished by a variety of techniques, including solution-based deposition techniques, as described above with respect to the planarization coating composition. In certain embodiments, the deposited conductive composition is subsequently annealed to form a conductive layer. Annealing may be accomplished via a variety of techniques, including, for example, thermal heating, radiation with light (e.g., infrared, microwave, ultraviolet), and the like.

The conductive layer need not fully cover the surface of the cured planarization film. For example, depending upon the deposition technique, the conductive layer may include a plurality of conductive features arranged according to a pre-determined pattern or design. Conductive features include, for example, electrodes, pads, interconnects, traces, lines, tracks, and the like.

Additional material layers may be included in the multilayer structure. The multilayer structure may be part of an electronic device (or a component thereof). Electronic devices, include, for example, thin film transistors, light emitting diodes, RFID tags, photovoltaics, displays, printed antenna, and the like.

In certain embodiments, the flexible printed electronics disclosed herein may be manufactured via roll-to-roll processing methods. Roll-to-roll printing is commonly used to produce a plurality of images on a single length of media. In roll-to-roll printing, a length of media in the form of a print substrate is fed from an input roll to a printing device. The printing device prints on the substrate, and the substrate is then fed to an output roll. One application for roll-to-roll printing is in flexible printed electronics. When the substrate is not substantially smooth, it can introduce distortion to the output roll which may disrupt normal operations, lower yields, and hinder the resultant device performance. Accordingly, in certain embodiments disclosed herein, the planarization coating composition is deposited on the substrate by a roll-to-roll processing method, and, according to certain embodiments, a conductive layer is applied to a planarization-coated substrate via a roll-to-roll processing method.

As described above, in certain embodiments, the cured planarization films provide excellent adhesion of conductive layers to an underlying substrate, while maintaining the desired properties of the conductive layers, including the conductivity of the conductive layers. In certain embodiments, the conductivity of the conductive layer in the multilayer structure is greater than about 5 ohms, such as greater than about 10 ohms, greater than about 15 ohms, or greater than about 20 ohms. In certain embodiments, the conductivity of the conductive layer ranges from about 5 ohms to about 20 ohms, such as from about 7 ohms to about 18 ohms or from about 10 ohms to about 15 ohms. Conductivity may be measured by any means known in the art, including measuring the electrodes with an ohmeter or measuring the volume resistivity of the conductive layer with a commercially-available 4-point probe apparatus, such as, for example, those available from Cascade Microtech, Inc.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein.

While the present teachings have been illustrated with respect to one or more implementations, alterations and/or modifications can be made to the illustrated examples without departing from the spirit and scope of the appended claims. In addition, while a particular feature of the present teachings may have been disclosed with respect to only one of several implementations, such feature may be combined with one or more other features of the other implementations as may be desired and advantageous for any given or particular function. Furthermore, to the extent that the terms “including”, “includes”, “having”, “has”, “with” or variants thereof are used in either the detailed description and the claims, such terms are intended to be inclusive in a manner similar to the term “comprising”. Further, in the discussion and claims herein, the term “about” indicates that the value listed may be somewhat altered, as long as the alteration does not result in nonconformance of the process or structure to the illustrated embodiment. Finally, “exemplary” indicates the description is used as an example, rather than implying that it is an ideal.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompasses by the following claims.

### EXAMPLES

Two samples of a planarization coating composition were prepared by mixing an acrylic polyol (Joncryl® 942, from BASF), a tris(alkoxycarbonylamino) triazine crosslinker (Cymel® NF2000A from Allnex, 50.4 wt % in n-butanol, pH=5.5, viscosity=32 cps), a blocked para-toluenesulfonic acid catalyst (Nacure® XP-357 from King Industries), and a solvent (methylene chloride).

In the first sample, a clear coating solution was obtained with the composition of Joncryl® 942/Cymel® NF2000A/Nacure® XP-357 in an amount of 74.2/24.8/1, respectively, in methylene chloride (about 30 weight % solid). In the second sample, a clear coating solution was obtained with the composition of Joncryl® 942/Cymel® NF2000A/Nacure® XP-357 in an amount by weight % of 64.3/34.7/1, respectively, in methylene chloride (about 30 weight solid), respectively. The compositions are shown below in Table 1.

TABLE 1
Sample Planarization Coating Compositions

| Ingredient | Sample #1 | Sample #2 |
|---|---|---|
| Acrylic polyol (Joncryl ®) | 22.3 parts | 19.3 parts |
| Tris(alkoxycarbonylamino) triazine | 7.4 parts | 10.4 parts |
| crosslinker (Cymel ®) | | |
| Para-toluenesulfonic acid (Nacure ®) | 0.3 part | 0.3 part |
| Methylene cholide | 70 parts | 70 parts |

Each of the two samples was draw-bar coated on a 4 mil PEN substrate and subsequently cured at 140° C. for 10 minutes. The resulting planarization coatings were about 5 microns in thickness, and both of the coated PEN substrates remained flat with no curl.

Roughness: The surface roughness was measured using a Wyko® Rough Surface Tester Light Interferometer, and the results are shown in Table 2 below. The PEN substrate coated with the planarization composition Sample #1 was significantly smoother than either the uncoated PEN substrate or the acrylic-coated PET substrate. Likewise, the PEN substrate coated with the planarization composition Sample #2 was significantly smoother than either the uncoated PEN substrate or the acrylic-coated PET substrate.

TABLE 2

| | Lumirror ® | | | |
|---|---|---|---|---|
| | 41.31 (acrylic | Uncoated | PEN coated | PEN coated |
| | coated PET) | PEN | with Sample #1 | with Sample #2 |
| Rₐ (nm) | 6 | 65 | 2.3 | 1.5 |
| R_{z} (nm) | 50 | 608 | 21 | 17 |

Adhesion: To test the adhesion among the coated polyester substrates, a silver electrode comprising a silver ink available from InkTec of Gyeonggi-do, Korea, was printed in a specific testing pattern on both of the PEN substrates coated with the planarization coating Samples #1 and #2, using a Labratester printing machine. Subsequently, the ink pattern was thermally cured at 140° C. for 11 minutes. The resulting material was subjected to an adhesion test by sticking Scotch® Magic™ tape to the surface of the electrodes, then peeling the tape off of the surface, and visually evaluating the tape. Likewise, the same adhesion test was performed on a Lumirror® 41.31 acrylic-coated PET substrate that had been similarly printed with the same silver ink. Adhesion of the electrodes to the PEN substrate coated with the planarization coatings of Sample #1 and #2 as disclosed herein was excellent, and comparable to the adhesion of the electrodes on the Lumirror® substrate. The adhesion tests resulted in little or no silver ink or planarization coating peeling off the substrate and onto the clear tapes.

Resistance: The resistance of each of the silver lines in the testing pattern described above was measured and was comparable to that of the corresponding silver line coated on the control Lumirror™ 41.31, as shown below in Table 3. In other words, the disclosed planarization coatings have no negative impact on the conductivity of the silver electrode. The resistance for all of the Lumirror™ 41.31, the PEN substrate coated with the first planarization coating composition, and the PEN substrate coated with the second planarization coating composition were sufficiently conducitive, ranging in conductivity as shown below in Table 3.

TABLE 3
Resistance (Ohms) of Printed Substrates

| | Electrodes | | |
|---|---|---|---|
| | printed on | Electrodes | Electrodes |
| | Lumirror ® | printed on PEN | printed on PEN |
| | 41.31 (acrylic | coated with | coated with |
| | coated PET) | Sample #1 | Sample #2 |
| Electrode 1 | 18.2 | 19.1 | 17.8 |
| Electrode 2 | 12.4 | 12.2 | 11.9 |
| Electrode 3 | 6.8 | 7.1 | 6.9 |

What is claimed is:

1. A planarization coating composition for polyester substrates comprising:
at least one acrylic polyol;
at least one melamine carbamate crosslinker;
at least one solvent; and
optionally at least one acid catalyst;
wherein the at least one melamine carbamate crosslinker is free of formaldehyde.

2. The planarization coating composition of claim 1, wherein the at least one melamine carbamate crosslinker is a tris(alkoxycarbonylamino) triazine.

3. The planarization coating composition of claim 2, wherein the tris(alkoxycarbonylamino) triazine is compound of a formula I: 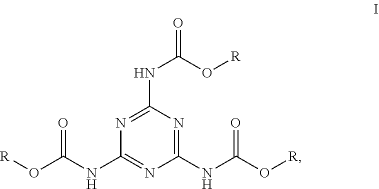
wherein R is chosen from methyl and n-butyl.

4. The planarization coating composition of claim 1, wherein the at least one melamine carbamate crosslinker is present in the planarization coating composition in an amount ranging from about 5 wt % to about 65 wt %, based on a total weight of solids in the composition.

5. The planarization coating composition of claim 1, wherein the at least one acrylic polyol is present in the planarization coating composition in an amount ranging from about 35 wt % to about 95 wt %, based on a total weight of solids in the composition.

6. The planarization coating composition according to claim 1, wherein the at least one solvent is methylene chloride.

7. The planarization coating composition of claim 1, wherein the at least one acid catalyst is chosen from dodecylbenzene sulfonic acid, trifluoromethane sulfonic acid, polyphosphoric acid, dimethyl acid pyrophosphate, dinonyl naphthalene disulfonic acid, para-toluenesulfonic acid, oxalic acid, maleic acid, carboxylic acid, ascorbic acid, malonic acid, succinic acid, tartaric acid, citric acid, and methanesulfonic acid.

8. The planarization coating composition of claim 1, wherein the at least one acid catalyst is present in the planarization coating composition in an amount ranging from about 0.5 wt % to about 6 wt %, based on a total weight of solids in the composition.

9. A method of making a planarization-coated substrate for flexible printed electronics, comprising:
providing a polyester substrate;
depositing over the polyester substrate a planarization coating composition comprising at least one acrylic polyol, at least one melamine carbamate crosslinker, at least one solvent, and optionally at least one acid catalyst, wherein the at least one melamine carbamate crosslinker is free of formaldehyde; and
curing the planarization coating composition to form a cured planarization film adhered to the polyester substrate.

13. The method of claim 9, wherein the planarization coating composition is cured at a temperature ranging from about 100° C. to about 140° C.

14. The method of claim 9, wherein the planarization coating composition is cured for a time ranging from about 5 minutes to about 20 minutes.

15. The method of claim 9, wherein the polyester substrate is chosen from polyethylene naphthalate and polyethylene terephthalate.

16. A planarization-coated substrate for flexible printed electronics, comprising:
a polyester substrate; and
a cured planarization film adhered over the polyester substrate comprising at least one acrylic polyol, at least one melamine carbamate crosslinker, at least one solvent, and optionally at least one acid catalyst, wherein the at least one melamine carbamate crosslinker is free of formaldehyde.

17. The planarization-coated substrate of claim 16, wherein the cured planarization film has a thickness ranging from about 0.1 micron to about 20 microns.

18. The planarization-coated substrate of claim 16, wherein the planarization-coated substrate has a surface roughness Rₐ value ranging from about 0.1 nm to about 15 nm.

19. The planarization-coated substrate of claim 16, further comprising at least one conductive composition deposited over the cured planarization film.

20. The planarization-coated substrate of claim 19, wherein the conductive composition has a conductivity ranging from about 2 ohms to about 100 ohms.
